(19) United States
(12) Patent Application Publication
(10) Pub. No.: US 2024/0227435 A9
(43) Pub. Date: Jul. 11, 2024

(54) SIDEWALL INSERT FOR A MOTORCYCLE TIRE

(71) Applicant: COMPAGNIE GENERALE DES ETABLISSEMENTS MICHELIN, Clermont-Ferrand (FR)

(72) Inventor: FLORIAN VILCOT, Clermont-Ferrand (FR)

(21) Appl. No.: 18/279,742

(22) PCT Filed: Mar. 1, 2022
(86) PCT No.: PCT/FR2022/050361

§ 371 Date: Aug. 31, 2023

(30) Foreign Application Priority Data
Mar. 3, 2021 (FR) FR2102041

(51) Int. Cl. B60B 7/01; B60B 7/02; B60B 7/04; B60B 7/08

(52) U.S. Cl. CPC B60B 7/01; B60B 7/02; B60B 7/04; B60B 7/08; B60C 2200/10

(57) ABSTRACT

An assembly (18) comprises a motorcycle tire (12) and at least one insert (16) for a sidewall of the tire (12). The insert (16) is removably fastened to the sidewall. The sidewall insert (16) comprises two free end edges arranged so that, when the tire (12) is mounted on a mounting support (14) in order to form a mounted assembly (10) and when the mounted assembly (10) is mounted on the motorcycle, the insert (16) can be mounted on and removed from the sidewall of the tire (12) without removing the mounted assembly (10) from the motorcycle. An insert (16) and a set of inserts that can be used in such an assembly (18), are disclosed together with a method for mounting an insert (16) or a set of inserts in order to form such an assembly (18).

The present invention relates to an insert for a sidewall of a motorcycle tyre, a set of a plurality of inserts, an assembly of an insert and a tyre, and a method for mounting an insert or a set of a plurality of inserts on a sidewall of a motorcycle tyre.

A sidewall insert for a motorcycle tyre is known in the prior art. Such a sidewall insert allows for the customized decoration of each tyre of the motorcycle on which it is mounted. Some users thus wish to avail of a tyre having a portion of the sidewall that is a similar or even identical colour to the fairing of the motorcycle. To this end, before the tyre is mounted on its mounting support, for example a rim, a qualified technician positions a ring in the appropriate colour between the tyre and each mounting edge of the mounting support so that, after the tyre has been inflated on the mounting support, the insert is trapped between the tyre and the mounting support. After inflation and balancing, the mounted assembly is then mounted on the motorcycle, either at the front on a fork arm, or at the rear on a swing arm.

However, when the user wishes to change the insert, either because it has been damaged or because they wish to change the colour, the user must call upon a qualified technician which, as well as being relatively costly, requires immobilizing the motorcycle in order to remove the mounted assembly from the motorcycle and allow the removal of the insert and the mounting of a new insert.

The invention aims to provide a sidewall insert for a motorcycle tyre that allows a change of insert that does not require intervention by a qualified technician.

To this end, the invention relates to an insert for a sidewall of a motorcycle tyre that is capable of being removably fastened to a sidewall of the motorcycle tyre, the sidewall insert forming an angular sector of a ring, the angular sector ranging from 330° to 380°, preferably from 350° to 370°, and more preferably being substantially equal to 360°, the insert comprising two free end edges arranged so that, when the tyre is mounted on a mounting support in order to form a mounted assembly and when the mounted assembly is mounted on the motorcycle, the insert can be mounted on and removed from the sidewall of the tyre without removing the mounted assembly from the motorcycle.

As the insert is removable, it can be mounted and removed at will without impairing the fastening of the insert to the sidewall of the tyre or damaging the tyre. This makes it possible envisage fastening using chemical means, for example using an adhesive layer, or fastening using mechanical means.

In the invention, so that the insert can be mounted and removed without removing the mounted assembly from the motorcycle, the insert is delimited by two free end edges making it possible, by moving them relative to each other, to create sufficient space for the insert to pass around a fork arm, a branch of a swing arm or a hub of the mounted assembly of the motorcycle. This thus avoids the need for intervention by a qualified technician.

The insert according to the invention can be such that the two free end edges can be placed in contact with each other so that the insert fully forms a ring around a central point, for example the axis of rotation of the tyre. The insert according to the invention can also be such that the two free end edges cannot be placed in contact with each other so that the insert only forms a portion of a ring. In both cases, the insert forms an angular sector of a ring. A ring extends circumferentially around a central point so that it makes a full turn around it. As described above, the angular sector of the ring delimited between each free end edge can be such that the insert fully forms the ring or can be such that the insert only forms a portion of the ring.

If the insert fully forms the ring, the ring has a discontinuity situated between the free end edges of the insert. The insert is such that a portion of the insert can be twisted so as to axially offset each free end edge relative to the other and allow the insert to pass around a fork arm, a branch of a swing arm or a hub of the mounted assembly of the motorcycle. Alternatively or in combination with the twisting, the insert is such that a portion of the insert can be compressed and a portion can be extended so as to circumferentially separate each free end edge from the other and allow the insert to pass around a fork arm, a branch of a swing arm or a hub of the mounted assembly of the motorcycle.

If the insert only forms a portion of the ring, the insert is such that there is sufficient space between each free end edge to allow the insert to pass around a fork arm, a branch of a swing arm or a hub of the mounted assembly of the motorcycle without moving one free end edge relative to the other. Alternatively, the insert is such that there is insufficient space between each free end edge to allow the insert to pass around a fork arm, a branch of a swing arm or a hub of the mounted assembly of the motorcycle. In this case, the insert is such that it comprises a portion that can be twisted and/or a portion that can be compressed and a portion that can be extended as described above.

In order to determine the angle of the angular sector, the theoretical circle passing through the two free end edges of the insert is taken into consideration. The angular sector is the angle between the straight lines joining the free end edges of the insert and the centre of the theoretical circle, which centre is situated equidistant from the free end edges of the insert and the concave side of the angular sector. The free end edges are the visible edges of the insert once it has been mounted on the tyre. The angle of the angular sector thus does not take into account any overlapping region between two portions of the insert, at least one portion of which is not visible once the insert has been mounted on the tyre.

A single insert per sidewall can be used, this insert fully forming the ring, which is discontinuous at one point. This makes it possible to limit the number of interfaces between free end edges and the adjustment thereof. When the two free end edges are in contact with each other, the ring forms a visually circumferentially continuous assembly.

Optionally and advantageously, the insert comprises first and second circumferential ends, and each first and second circumferential end bears complementary means for locking each first and second circumferential end to each other between:
an unlocked position in which each first and second circumferential end is movable relative to the other end, and
a locked position in which each first and second circumferential end is fixed relative to the other end and in which the complementary locking means interact with each other.

The locking means make it possible to ensure that the insert is held in its locked position and thus contribute to the durable fastening of the insert to the sidewall.

As a variant, each first and second circumferential end has a tapered profile that complements each second and first circumferential end respectively in at least part of an overlapping region between the first and second ends. The manufacturing of the insert is thus simplified. Tapered profile is given to mean that, considering the average thickness of the insert, the thickness of the insert is strictly less than the average thickness of the insert over at least one portion starting from each first and second end.

Preferably and optionally, the ring has a centre of symmetry.

The insert can thus be positioned without it being necessary to adjust the azimuth thereof relative to a precise point of the tyre sidewall.

In addition, the insert is radially delimited by a radially inner edge and a radially outer edge. Each radially inner and outer edge can follow, for example, a circular curve, an undulating curve, a crenelated curve, an oval curve, a straight curve or a broken curve around the central point between each free end edge. Here, the word “curve” is meant in the geometrical sense of the term according to which the word “curve” denotes certain subsets of the plane and of the usual space. For example, circles or portions of circles, straight lines, segments, polygonal lines and sinusoids are curves.

The tyre according to the invention is a motorcycle tyre. A motorcycle tyre is for example defined in the manual of the European Tyre and Rim Technical Organisation, or “ETRTO”, 2020 standard. Such a tyre has a section in a meridian section plane characterized in particular by a section height H and a nominal section width SW according to the ETRTO 2020 manual.

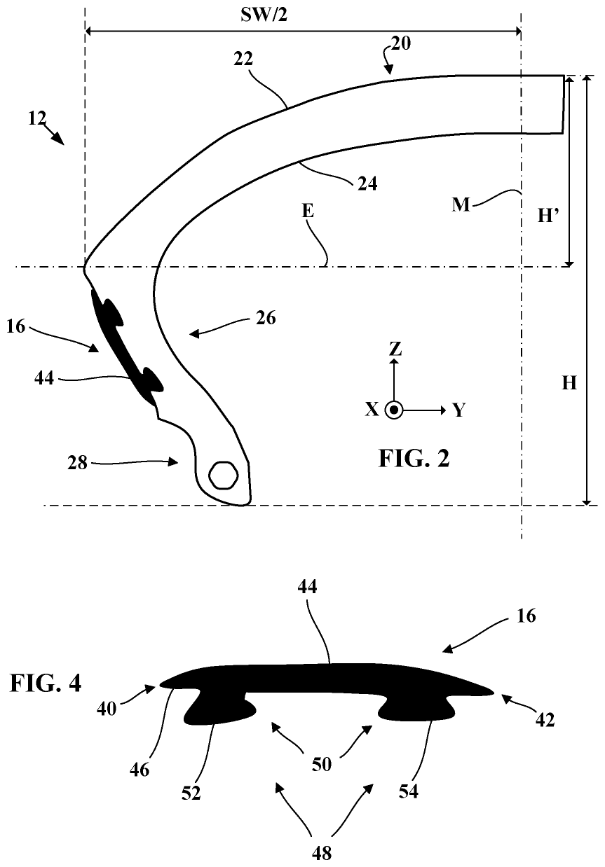

A motorcycle tyre, unlike a passenger vehicle tyre, has a very cambered tread, having a distinctive marked curvature. In particular, this curvature is characterized by the value of the curvature rate H′/SW, where H′ is the radial height of the tread separating the radially outermost point of the tyre from the equatorial circumferential plane E passing through the radially outer ends of said tread and SW is the nominal section width according to the manual of the ETRTO 2020 standard, as shown in FIG. 2. The nominal section width SW is usually measured on an axial line that is coincident with the equatorial circumferential plane E. In other cases, the nominal section width SW is measured on an axial line that is radially offset relative to the equatorial circumferential plane E. The value of SW is indicated on the marking of the sidewall of the tyre and the value of H′ is measured on the mounted tyre inflated to its nominal pressure on a measuring rim as defined according to the ETRTO 2020 manual. Such motorcycle tyres are preferably characterized by a curvature rate ranging from 0.15 to 0.50, preferably ranging from 0.20 to 0.40.

Advantageously, the tyres to which the invention relates are such that the nominal aspect ratio AR, expressed as a percentage and as defined according to the ETRTO 2020 manual, is at least equal to 40, preferably at least equal to 65, and is at most equal to 100, preferably at most equal to 80, and the nominal section width SW as defined according to the ETRTO 2020 manual is at least equal to 50 mm, preferably at least equal to 90 mm, and more preferably equal to 100 mm, and at most equal to 240 mm, preferably at most equal to 180 mm, more preferably at least equal to 150 mm. In addition, the nominal diameter D at the rim flange, as defined according to the ETRTO 2020 manual, is at least equal to 8 inches, preferably at least equal to 13 inches, and at most equal to 24 inches, preferably at most equal to 21 inches.

Axial direction is given to mean the direction substantially parallel to the main axis of the tyre, that is, the axis of rotation of the tyre.

Circumferential direction is given to mean the direction substantially perpendicular both to the axial direction and to a radius of the tyre (in other words, tangent to a circle centred on the axis of rotation of the tyre).

Radial direction is given to mean the direction along a radius of the tyre, that is, any direction that intersects the axis of rotation of the tyre and is substantially perpendicular to that axis.

Mid-plane of the tyre (denoted M) is given to mean the plane perpendicular to the axis of rotation of the tyre, which is situated axially halfway between the two beads and passes through the axial middle of the crown reinforcement.

Equatorial circumferential plane of the tyre (denoted E) is given to mean, in a meridian section plane, the plane passing through the equator of the tyre, perpendicular to the mid-plane and to the radial direction. The equator of the tyre is, in a meridian section plane (plane perpendicular to the circumferential direction and parallel to the radial and axial directions), the axis parallel to the axis of rotation of the tyre and passing through the axially outermost points of the tyre.

The height H of the tyre is the radial distance between the radially outermost point of the tread suitable for coming into contact with the ground and the radially innermost point of the tyre suitable for coming into contact with a support, for example a rim.

Meridian plane is given to mean a plane parallel to and containing the axis of rotation of the tyre and perpendicular to the circumferential direction.

Bead is given to mean the portion of the tyre suitable for making it possible to attach the tyre to a mounting support, for example a wheel comprising a rim. Each bead is thus in particular suitable for being in contact with a flange of the rim allowing it to be attached.

Any range of values denoted by the expression “between a and b” represents the range of values extending from more than a to less than b (that is, excluding the end-points a and b), whereas any range of values denoted by the expression “from a to b” means the range of values extending from a to b (that is, including the strict end-points a and b).

In one embodiment making it possible to obtain an insert generally following the curvature of the tyre, the insert forms an angular sector of a circular ring.

Circular ring is given to mean there is at least one circle all of the points of which belong to the insert. A circular ring can thus have radially inner and radially outer edges following a circular curve, or radially inner and radially outer edges following a crenelated or undulating curve.

In one embodiment making it possible to obtain an insert the radially inner and outer edges of which follow the curvature of the tyre, the insert comprising a radially inner edge and a radially outer edge, each radially inner and outer edge follows a circular curve.

Circular is given to mean that each radially inner and outer edge follows a curve the radius of curvature of which is non-infinite and constant.

Regardless of the embodiment, the insert preferably optionally comprises removable means for fastening the insert to the sidewall of the tyre comprising fastening means through reversible elastic clipping of the insert to the sidewall of the tyre.

Reversible clipping or snap-fastening is an assembly method based on the elastic deformation of the parts during mounting. Here, the elasticity of the sidewall of the tyre, generally made from an elastomeric material, is exploited to ensure the reversible fitting of the insert into the sidewall and therefore ensure that the insert is removable from the sidewall.

Compared to an insert comprising chemical fastening means, the insert comprising fastening means through reversible elastic clipping, which are mechanical means, make it possible to ensure that the insert is removable in the long term.

In one variant, the means for fastening the insert to the sidewall of the tyre through reversible elastic clipping comprise at least one fastening tab or nipple borne by a face of the insert intended to be concealed when the insert is fastened to the sidewall of the tyre. A tab is relatively elongated, whereas a nipple is less elongated. The tab or nipple is suitable for interacting with a complementary slot or cavity respectively made in the sidewall of the tyre. Unlike in a variant in which the tab or nipple is borne by the sidewall of the tyre, the variant described here makes it possible to preserve the general appearance of the sidewall of the tyre by avoiding elements that would protrude from the outer surface of the sidewall in the event that the sidewall of the tyre was not bearing an insert. In addition, in this variant, a tab or nipples can be used the radial width of which is relatively small compared to the height of the sidewall of the tyre on which it is intended to be mounted. The complementary recess made in the sidewall of the tyre thus also has a relatively small radial width compared to the height of the sidewall. When the user chooses to no longer use the insert, or uses one or more inserts forming an angular sector of less than 360°, the complementary recess or the portion of the complementary recess that is then visible on the sidewall does not detract from the aesthetics of the tyre.

In another variant that is equally advantageous from an aesthetic point of view when the tyre is without an insert, the insert comprising a radially inner edge and a radially outer edge, the means for fastening the insert to the sidewall of the tyre through reversible elastic clipping comprise at least one fastening tab borne by each radially inner and outer edge of the insert. In this variant, in order to avoid any unintentional unclipping of the insert from the sidewall, it will be ensured that the radius of curvature of the interface between the insert and the sidewall is relatively large.

In these two variants, the tab preferably extends over a total curvilinear length at least equal to 50% of the curvilinear length of the insert. The tab can be continuous or discontinuous.

In one configuration, the insert having a face intended to be visible when the insert is fastened to the sidewall of the tyre, the visible face is monochrome and/or has a single appearance texture. Monochrome is given to mean that the face of the insert is only a single colour. Single appearance texture is given to mean that each point of the surface of the insert has the same orientation, roughness and undulation characteristics which define, as is known, a surface appearance.

In this configuration, the manufacturing costs of the insert are reduced. In the embodiment in which a plurality of inserts are used on the same sidewall, it is thus possible to have a plurality of colours and/or a plurality of appearance textures by using inserts that each have a visible face that is monochrome and/or has a single appearance texture.

In another configuration, the insert having a face intended to be visible when the insert is fastened to the sidewall of the tyre, the visible face is polychrome and/or has a plurality of different appearance textures. Polychrome is given to mean that the face of the insert has, on different parts of the insert, a plurality of distinct colours. Different appearance textures is given to mean that several parts of the surface of the insert have different orientation and/or roughness and/or undulation characteristics.

For example, an insert can be envisaged comprising portions of the visible face in one colour, portions of the visible face comprising a graphic, for example writing, in the first colour on a background of a second colour, the graphic being produced with an appearance texture identical to or different from the texture of the portions without a graphic.

This thus makes it possible to have a plurality of colours and/or a plurality of appearance textures without having to worry about the interfaces between a potential plurality of inserts.

In a particularly low-cost embodiment, the insert is formed from a monolithic material. Preferably, the monolithic material is through-dyed. Advantageously, the monolithic material comprises a polymeric material. The polymeric material can be heat-curable or thermoplastic.

In another embodiment, the insert comprises a first part formed from a first monolithic material and a second part formed form a second monolithic material different from the first monolithic material. Advantageously, the first part is intended to be visible when the insert is fastened to the sidewall of the tyre and the second part comprises means for fastening through reversible elastic clipping. The first part thus forms a visible appearance part and the second part forms afunctional fastening part.

Preferably, the first part is through-dyed. Advantageously, the first monolithic material comprises a polymeric material. The polymeric material can be heat-curable or thermoplastic. A first polymeric material and a second metallic material overmoulded by the first material can be envisaged. As a variant, the first part is made from a natural material such as wood, cotton, hemp, linen or leather. Whether by means of a polymeric or natural material, it can be envisaged that these materials form fabrics, whether smooth or tousled, for example in order to imitate fur.

In another embodiment, the insert can comprise means for reflecting light, for example such as a reflective surface. Alternatively or in combination, the insert can also comprise means for generating light, for example such as a strip of light-emitting diodes.

The invention also relates to the use of an insert for a sidewall of a motorcycle tyre that is capable of being removably fastened to a sidewall of the motorcycle tyre, the sidewall insert forming an angular sector of a ring, the insert comprising two free end edges arranged so that, when the tyre is mounted on a mounting support in order to form a mounted assembly and when the mounted assembly is mounted on the motorcycle, the insert can be mounted on and removed from the sidewall of the tyre without removing the mounted assembly from the motorcycle.

In one embodiment using the insert described above, a single sidewall insert is used, the single insert being suitable for being removably fastened to a sidewall of a motorcycle tyre, the single sidewall insert forming an angular sector of a ring, the angular sector ranging from 330° to 380°, preferably from 350° to 370°, and more preferably being substantially equal to 360°, and comprising two free end edges arranged so that, when the tyre is mounted on a mounting support in order to form a mounted assembly and when the mounted assembly is mounted on the motorcycle, the single insert can be mounted on and removed from the sidewall of the tyre without removing the mounted assembly from the motorcycle.

The invention also relates to the use of a set of a plurality of inserts, in which each of the inserts in the set is suitable for being removably fastened to a sidewall of a motorcycle tyre, each sidewall insert comprising two free end edges arranged so that, when the tyre is mounted on a mounting support in order to form a mounted assembly and when the mounted assembly is mounted on the motorcycle, each insert can be mounted on and removed from the sidewall of the tyre without removing the mounted assembly from the motorcycle.

Using the set according to the invention, it is thus possible to envisage straight inserts that do not individually form an angular sector of a ring but the assembly of which with each other can define a ring in the shape of a polygon.

Preferably, the number of inserts in the set ranges from 2 to 10, more preferably from 2 to 6.

In one embodiment, a set is used in which, the angular sector of each insert being substantially equal to 360° N, with N≥2, N preferably ranging from 2 to 10, N more preferably ranging from 2 to 6, the inserts in the set fully form a discontinuous ring when the inserts are arranged circumferentially adjacent to and in contact with each other.

In this embodiment, the inserts in the set are suitable for being fastened to the same sidewall and fully form a ring that is discontinuous at a plurality of points. Each insert only forms a portion of the ring. In a variant of this embodiment, a plurality of inserts of different colours and/or appearance textures can be used in order to form all or part of the ring and optimally customize the tyre.

In this embodiment, optionally and advantageously, each insert comprises first and second circumferential ends, and each first and second circumferential end respectively bears first and second complementary means for locking each first and second circumferential end to each other between:
an unlocked position in which each first and second circumferential end is movable relative to a second and a first circumferential end respectively of an insert bearing identical complementary locking means, and
a locked position in which each first and second circumferential end is fixed relative to a second and a first circumferential end respectively of an insert bearing identical complementary locking means and in which the complementary locking means of the two inserts interact with each other.

In a similar manner to the embodiment described above, the locking means make it possible to ensure that each insert is held in its locked position with an adjacent insert and thus contribute to the durable fastening of the inserts to the sidewall.

In this embodiment, as a variant, each first and second circumferential end of each insert has a tapered profile that complements each second and first circumferential end respectively of an insert comprising identical first and second circumferential ends, in at least part of an overlapping region between the first and second ends of the inserts.

In another embodiment, a set is used in which, the angular sector of each insert being substantially equal to (360°—A)/N with N≥2 and A ranging from 10° to 330°, each insert is circumferentially at a distance from the two inserts adjacent to it when the inserts are circumferentially evenly distributed relative to each other.

In this embodiment, the insert can be used within a set of a plurality of inserts, the inserts in this set being suitable for being fastened to the same sidewall and form only one portion of the ring. The inserts can be separated two by two by an uncovered angular sector of the sidewall. The sum of the angles of the uncovered angular sectors of the sidewall is equal to A°.

The invention also relates to an assembly of a motorcycle tyre and at least one insert for a sidewall of the tyre, the or each insert being removably fastened to the sidewall, the or each sidewall insert comprising two free end edges arranged so that, when the tyre is mounted on a mounting support in order to form a mounted assembly and when the mounted assembly is mounted on the motorcycle, the insert can be mounted on and removed from the sidewall of the tyre without removing the mounted assembly from the motorcycle.

In one embodiment, the assembly comprises a single sidewall insert removably fastened to the sidewall, the sidewall insert forming an angular sector of aring, the angular sector ranging from 330° to 380°, preferably from 350° to 370°, and more preferably being substantially equal to 360°.

In one embodiment comprising N≥2 inserts, the angular sector of each insert being substantially equal to 360°/N, N preferably ranging from 2 to 10, N more preferably ranging from 2 to 6, the sidewall comprises N portions arranged circumferentially adjacent to each other, each of the N inserts interacting with each portion of the sidewall arranged circumferentially adjacent to each other so that they fully form a discontinuous ring.

In another embodiment comprising N≥2 inserts, the angular sector of each insert being substantially equal to (360°—A)/N with A ranging from 10° to 330°, the sidewall comprises:
N covered portions of the sidewall interacting with each of the N inserts, and
N′≥2 uncovered portions of the sidewall without an insert, each covered portion of the sidewall being circumferentially adjacent to and arranged between two uncovered portions of the sidewall.

Preferably, in this other embodiment, each uncovered portion of the sidewall is incapable of interacting with each of the N inserts.

The invention further relates to a method for mounting an insert on a sidewall of a motorcycle tyre, the insert being capable of being removably fastened to the sidewall of the motorcycle tyre, the sidewall insert forming an angular sector of a ring, the angular sector ranging from 330° to 380°, preferably from 350° to 370°, and more preferably being substantially equal to 360°, the insert comprising two free end edges, in which method:
in a step of passing the insert around a fork arm, a branch of a swing arm or a hub of the mounted assembly of the motorcycle:
   each free end edge is axially offset relative to the other so as to allow the insert to pass around the fork arm, the branch of the swing arm or the hub of the mounted assembly, and/or
   each free end edge is circumferentially separated from the other so as to allow the insert to pass around the fork arm, the branch of the swing arm or the hub of the mounted assembly,
the insert is removably fastened to the sidewall.

The invention finally relates to a method for mounting a plurality of inserts on a sidewall of a motorcycle tyre, each insert being capable of being removably fastened to the sidewall of the motorcycle tyre, the sidewall insert forming an angular sector of a ring and comprising two free end edges, the angular sector of each insert being substantially equal to 360°/N with N≥2, N preferably ranging from 2 to 10, N more preferably ranging from 2 to 6, or the angular sector of each insert being substantially equal to (360°—A)/N with N≥2 and A ranging from 10° to 330°, in which method:
in a step of passing each insert around a fork arm, a branch of a swing arm or a hub of the mounted assembly of the motorcycle:
   the or each insert being such that there is sufficient space between each free end edge to allow the or each insert to pass around the fork arm, the branch of the swing arm or the hub of the mounted assembly without moving one free end edge relative to the other, the fork arm, the branch of the swing arm or the hub of the mounted assembly is passed into the space between each free end edge, or
   the or each insert being such that there is insufficient space between each free end edge to allow the or each insert to pass around the fork arm, the branch of the swing arm or the hub of the mounted assembly:
      each free end edge is axially offset relative to the other so as to allow each insert to pass around the fork arm, the branch of the swing arm or the hub of the mounted assembly, and/or
      each free end edge is circumferentially separated from the other so as to allow the fork arm, the branch of the swing arm or the hub of the mounted assembly to pass into the space between each free end edge,
each insert is removably fastened to the sidewall.

These two methods according to the invention can be implemented when the mounted assembly is mounted on the motorcycle and also when the mounted assembly is removed from the motorcycle.

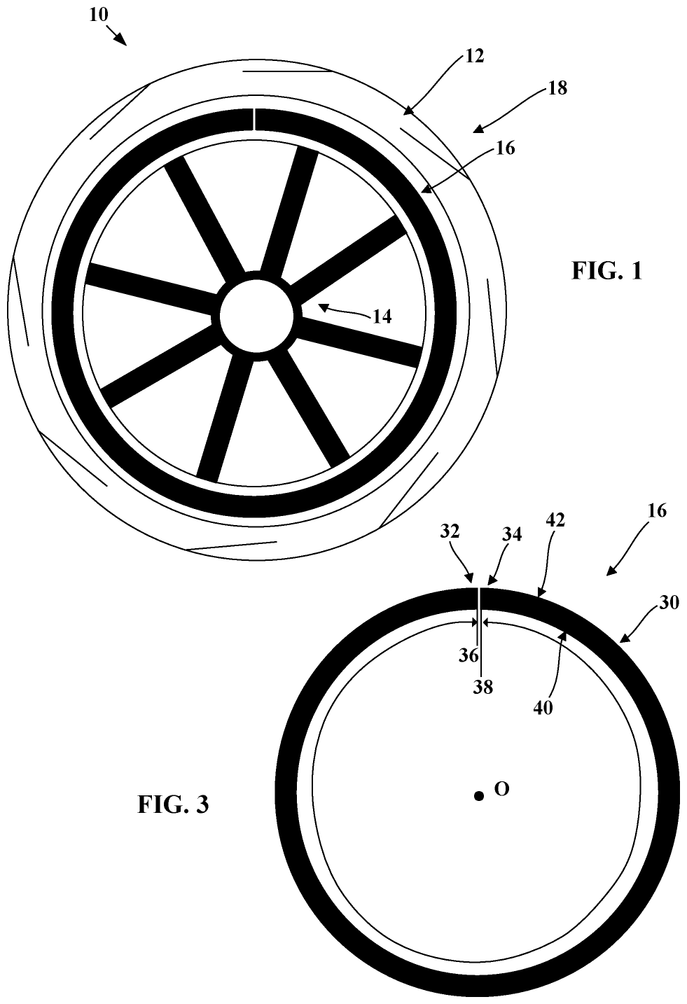

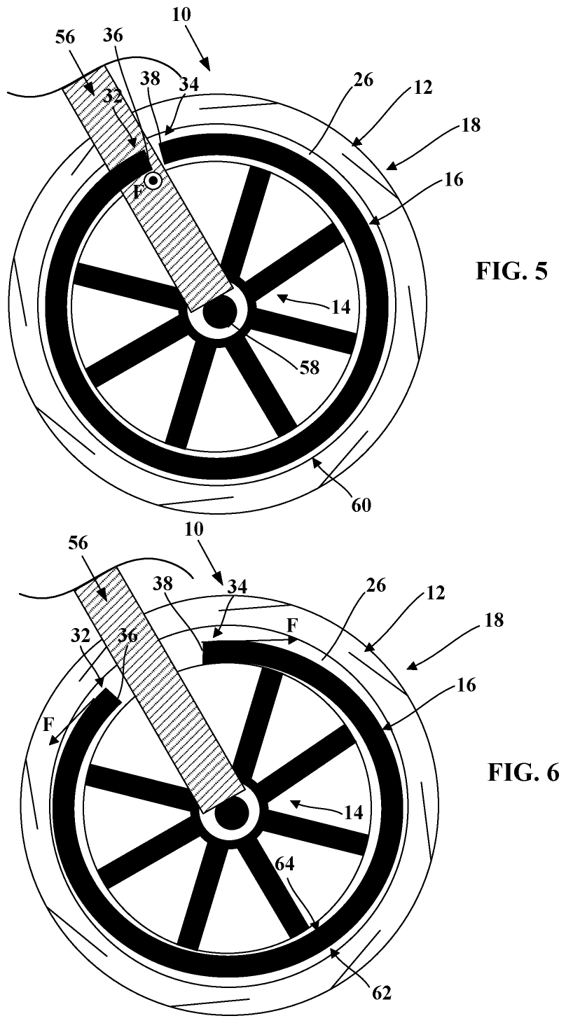

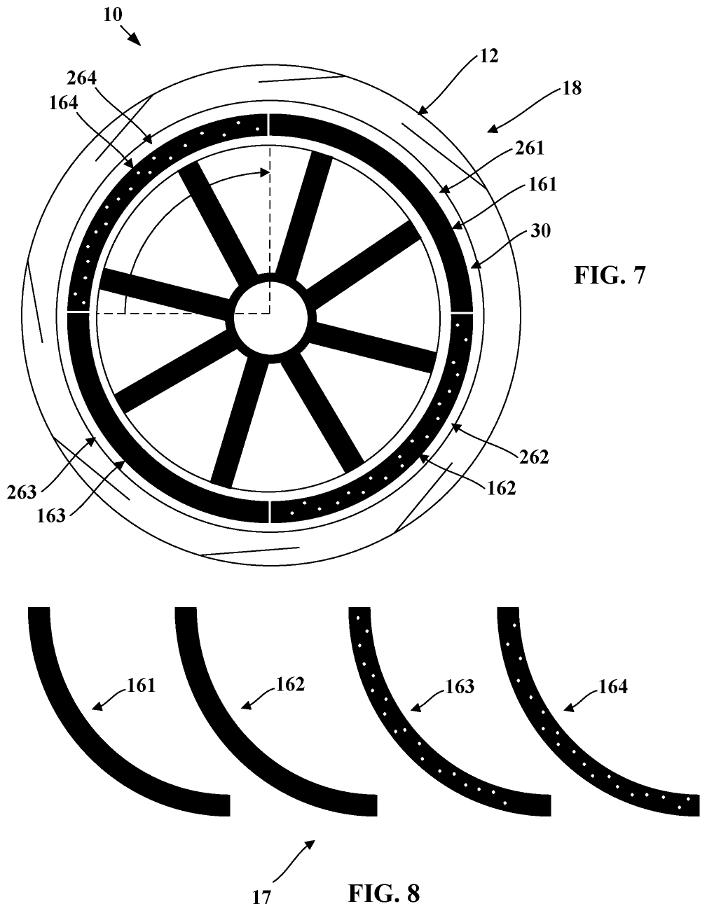

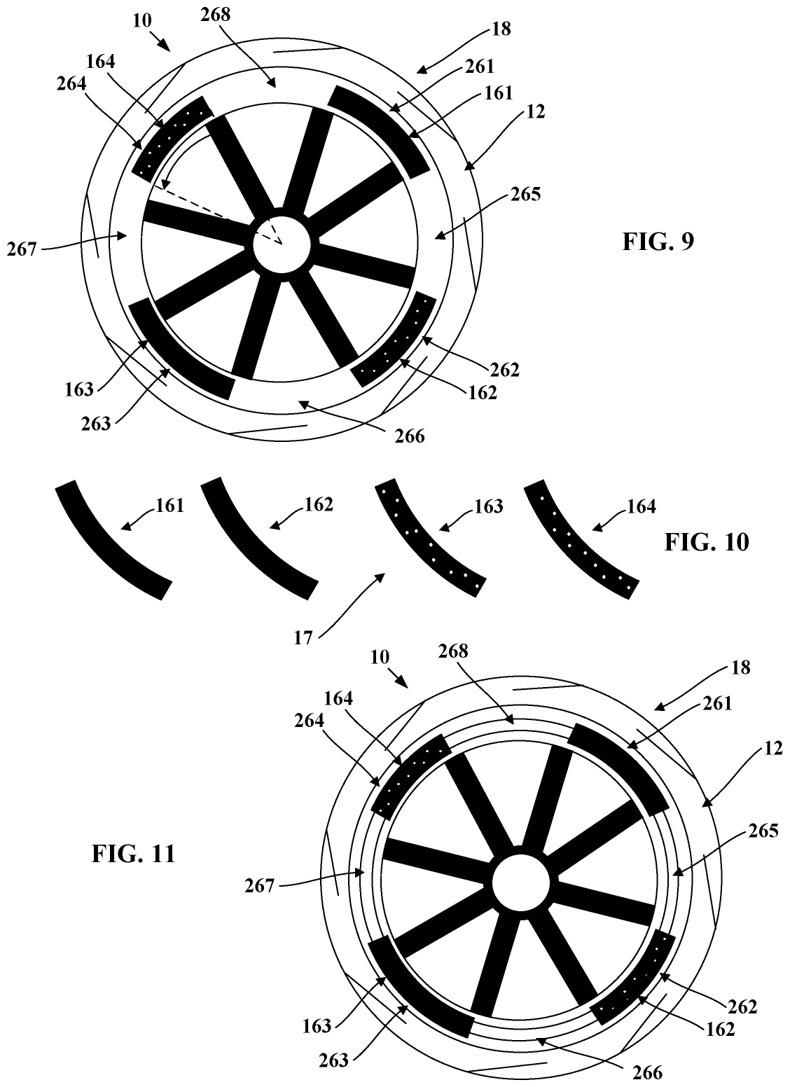

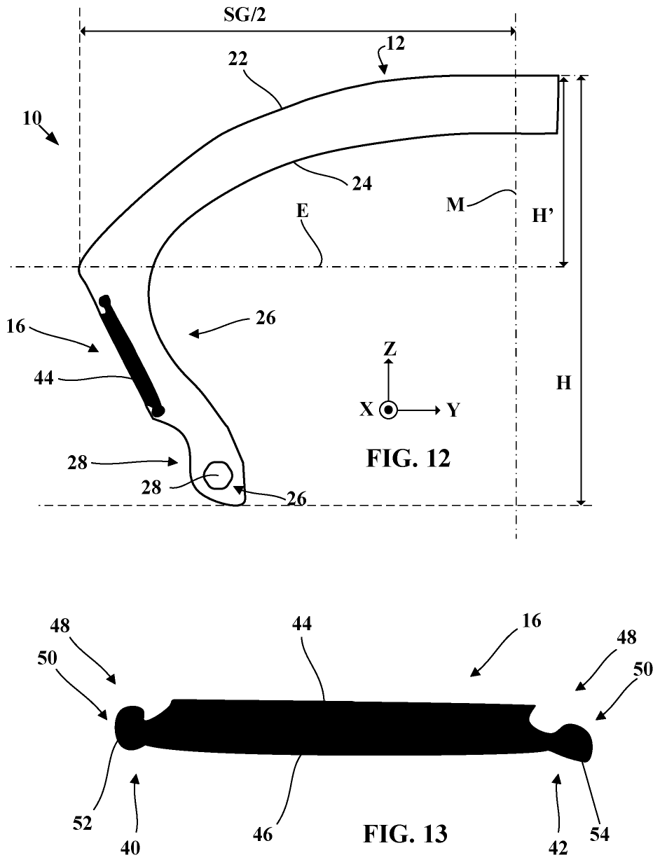

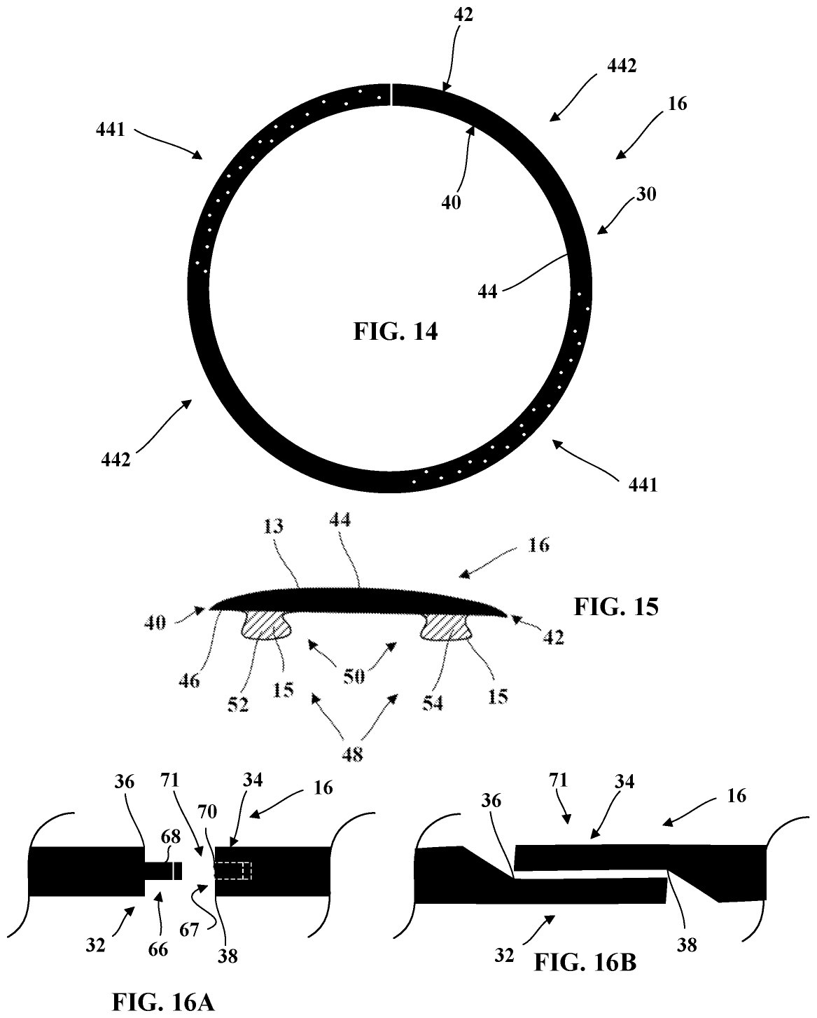

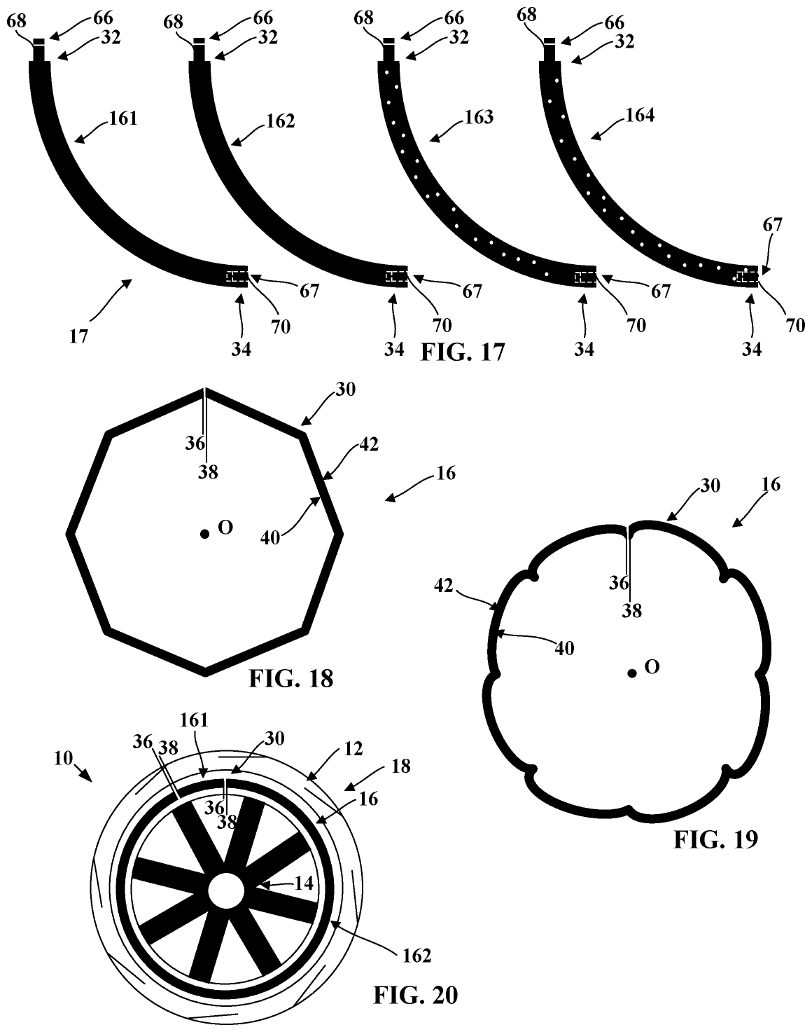

The invention and its advantages will be easily understood in the light of the detailed description and the non-limiting exemplary embodiments which follow, and from the following figures, which relate to these examples and in which:
FIG. 1 is a side view of a mounted assembly comprising an assembly according to a first embodiment of the invention comprising a tyre and an insert according to a first embodiment of the invention,
FIG. 2 is a cross-sectional view of the assembly in FIG. 1,
FIG. 3 is a side view of the insert of the assembly in FIG. 1,
FIG. 4 is a cross-sectional view of the insert in FIG. 3,
FIGS. 5 and 6 are side views of a mounted assembly comprising the assembly in FIG. 1 mounted on a mounting support mounted on a motorcycle and illustrating two variants of the method for mounting the insert on the tyre,
FIG. 7 is a similar view to FIG. 1 of an assembly according to a second embodiment comprising a tyre and a set of a plurality of inserts according to a first embodiment, each insert being according to a second embodiment,
FIG. 8 is a side view of the set of a plurality of inserts in FIG. 7,
FIGS. 9 and 10 are similar views to FIGS. 7 and 8 of an assembly according to a third embodiment and of a set of a plurality of inserts according to a second embodiment of the invention, each insert being according to a third embodiment,
FIG. 11 is a similar view to FIGS. 7 and 9 of an assembly according to afourth embodiment comprising the set of a plurality of inserts according to the second embodiment in FIGS. 9 and 10,
FIG. 12 is a similar view to FIG. 2 of an assembly according to a fifth embodiment comprising an insert according to a fourth embodiment,
FIG. 13 is a similar view to FIG. 4 of the insert in FIG. 12,
FIG. 14 is a similar view to FIG. 3 of an insert according to a fifth embodiment,
FIG. 15 is a similar view to FIGS. 4 and 13 of an insert according to a sixth embodiment,
FIG. 16A is a detailed view of an insert according to a seventh embodiment,
FIG. 16B is a detailed view of an insert according to a variant of the insert in FIG. 16A,
FIG. 17 is a similar view to FIGS. 8 and 10 of a set of a plurality of inserts according to a third embodiment,
FIGS. 18 and 19 is a similar views to FIGS. 3 and 14 respectively of inserts according to an eighth and a ninth embodiment,
FIG. 20 is a similar view to FIG. 1 of an assembly according to a sixth embodiment comprising inserts according to tenth and eleventh embodiments.

A frame of reference X, Y, Z corresponding respectively to the usual axial (Y), radial (Z) and circumferential (X) directions of a tyre is shown in the figures relating to the tyre.

FIG. 1 shows a mounted assembly denoted by the general reference 10. The mounted assembly 10 comprises a motorcycle tyre 12 and a mounting support 14 on which the tyre 12 is mounted. The mounted assembly 10 also comprises an insert 16 for a sidewall of the tyre 12 according to a first embodiment. The tyre 12 and the insert 16 form an assembly 18 according to a first embodiment.

With reference to FIG. 2, the tyre 12 substantially exhibits symmetry of revolution about an axis substantially parallel to the axial direction Y. Here, the tyre 12 is suitable for a motorcycle and has dimensions 130/80B17. Being suitable for a motorcycle, the tyre is in particular characterized by a curvature rate ranging from 0.15 to 0.50, preferably ranging from 0.20 to 0.40, and here equal to 0.36 with H′=47 mm and SW=130 mm.

The tyre 12 comprises a crown 20 comprising a tread 22 suitable for coming into contact with the ground when the tyre is running. The tyre 12 also comprises a sealing layer 24 for sealing against an inflation gas being suitable for defining a closed internal cavity with the mounting support 14 once the tyre 12 has been mounted on the mounting support 14. The tyre 12 comprises two sidewalls 26 that extend the crown 20 radially inwards. The tyre 12 also has two beads 28 radially inside the sidewalls 26. Each sidewall 26 connects each bead 28 to the crown 20.

As illustrated in FIGS. 1 and 3, the insert 16 forms an angular sector of a circular ring 30 having a centre of symmetry O and comprises first and second circumferential ends 32, 34 respectively bearing first and second free end edges 36, 38. The ring 30 is discontinuous at a single point. The insert 16 also comprises a radially inner edge 40 and a radially outer edge 42. Each radially inner and outer edge 40, 42 follows a circular curve. In this first embodiment, the angular sector formed by the insert 16 between the first and second free end edges 36, 38 ranges from 330° to 380°, preferably from 350° to 370°, and here is substantially equal to 360°.

With reference to FIGS. 2 and 4, the insert has a face 44 visible when the insert 16 is fastened to the sidewall 26 and a face 46 by which the insert 16 bears against the sidewall 26, the bearing face 46 being intended to be concealed when the insert 16 is fastened to the sidewall 26. Here, the visible face 44 is monochrome and has a single appearance texture.

The insert 16 comprises removable means 48 for fastening the insert 16 to the sidewall 26. These removable fastening means 48 comprise means 50 for fastening the insert 16 to the sidewall 26 through reversible elastic clipping. The means 50 for fastening through reversible elastic clipping here comprise two fastening tabs 52, 54 borne by the bearing face 46. The insert in FIG. 4 is thus capable of being removably fastened to the sidewall 26. In FIGS. 1 and 2, the insert 16 is removably fastened to the sidewall 26.

The sidewall 26 of the tyre 12 comprises fastening means that complement the removable fastening means 48 of the insert 15. The complementary fastening means formed in the tyre will preferably be positioned sufficiently far away from the bead to ensure that these complementary fastening means do not catch in the rim flange when the tyre 12 is mounted on the mounting support 14.

The insert 16 is formed from a through-dyed monolithic material. Here, the monolithic material comprises a thermoplastic polymeric material, here polypropylene.

As shown in FIGS. 5 and 6, the insert 16 is such that the first and second free end edges 36, 38 are arranged so that, when the tyre 12 is mounted on the mounting support 14 in order to form the mounted assembly 10 and when the mounted assembly 10 is mounted on the motorcycle, here on a fork 56 of the motorcycle by means of a hub 58 of the mounted assembly 10, the insert 16 can be mounted on and removed from the sidewall 26 without removing the mounted assembly 10 from the motorcycle.

During the method for mounting the insert 16 on the sidewall 26, a step of passing the insert 16 around the fork arm 56 or the hub 58 is carried out.

To this end, as shown in FIG. 5, each first and second free end edge 36, 38 can be offset relative to the other so as to allow the insert 16 to pass around the fork arm 56 or the hub 58 of the mounted assembly 10. In order to achieve this offset, a force F is applied to at least one of the first and second ends 32, 34 so as to twist a portion 60 of the insert 16.

As shown in FIG. 6, each first and second free end edge 36, 38 can also be circumferentially separated from the other so as to allow the insert 16 to pass around the fork arm 56 or the hub 58 of the mounted assembly 10. In order to achieve this circumferential separation, aforce F is applied to each first and second end 32, 34 so as to compress a portion 62 of the insert 62 and extend a portion 64 of the insert 16.

Of course, each first and second free end edge 36, 38 can be simultaneously axially offset and circumferentially separated.

Once the step of passing the insert 16 has been carried out, the insert 16 is removably fastened to the sidewall 26.

An assembly according to a second embodiment will now be described with reference to FIGS. 7 and 8, comprising a tyre and a set of a plurality of inserts according to a first embodiment. Elements similar to those described in the first embodiment are denoted by identical reference signs.

With reference to FIG. 7, the assembly 18 comprises N≥2 inserts 161, 162, 163, 164 with N=4 here. Each sidewall 26 of the tyre 12 of the assembly 18 comprises N=4 portions 261, 262, 263, 264, arranged circumferentially adjacent to each other. Each of the N inserts 161, 162, 163, 164 interacts with each sidewall portion 261, 262, 263, 264 arranged circumferentially adjacent to each other so that they fully form a ring 30 that is discontinuous at a plurality of points.

Each visible face of each insert 161, 162 is monochrome and has a single appearance texture. Each visible face of each insert 163, 164 is polychrome and has a single appearance texture, here the same appearance texture as the visible faces of the inserts 161, 162. Here, the inserts 161, 162 are identical so that their respective visible faces are the same single first colour. The inserts 163, 164 are identical so that their respective visible faces are the same colours.

Unlike the insert according to the first embodiment, the angular sector of each insert 161, 162, 163, 164 is substantially equal to 360°/N with N=4 here, that is, substantially equal to 900.

With reference to FIG. 8, the inserts 161, 162, 163, 164 form a set of inserts 17. When the inserts 161, 162, 163, 164 in the set 17 are arranged circumferentially adjacent to and in contact with each other, whether on a tyre sidewall as shown in FIG. 7 or on a flat support, the inserts 161, 162, 163, 164 fully form a ring 30 that is discontinuous at a plurality of points as illustrated in FIG. 7.

In this second embodiment, during the method for mounting the inserts 161, 162, 163, 164 on the sidewall 26, a step of passing each insert 161, 162, 163, 164 around the fork arm 56 or the hub 58 is carried out.

Here, each insert 161, 162, 163, 164 is such that there is sufficient space between each free end edge to allow each insert 161, 162, 163, 164 to pass around the fork arm or the hub of the mounted assembly without moving one free end edge relative to the other.

The fork arm or the hub of the mounted assembly is thus simply passed into the space between each free end edge.

Each insert 161, 162, 163, 164 is then removably fastened to the sidewall 26.

An assembly according to a third embodiment will now be described with reference to FIGS. 9 and 10, comprising a tyre and a set of a plurality of inserts according to a second embodiment. Elements similar to those described in the preceding embodiments are denoted by identical reference signs.

With reference to FIG. 9, each sidewall 26 of the tyre 12 of the assembly 18 comprises N=4 covered portions 261, 262, 263, 264 of the sidewall interacting with each of the N inserts 161, 162, 163, 164. Each sidewall 26 of the tyre 12 of the assembly 18 comprises N′=4 uncovered portions 265, 266, 267, 268 of the sidewall without an insert.

Each covered portion 261, 262, 263, 264 is circumferentially adjacent to and arranged between two uncovered portions 265, 266, 267, 268. Here, each uncovered portion 265, 266, 267, 268 is incapable of interacting with each of the inserts 161, 162, 163, 164.

Unlike the inserts of the second embodiment, the angular sector of each insert 161, 162, 163, 164 is substantially equal to (360°—A)/N, with N≥2 and A ranging from 10° to 330°. In this instance, N=4 and A=180°, so that the angular sector of each insert 161, 162, 163, 164 is equal to 45°.

Unlike the inserts of the second embodiment, when the inserts 161, 162, 163, 164 in the set 17 are circumferentially evenly distributed relative to each other, whether on a tyre sidewall as shown in FIG. 9 or on a flat support, each insert 161, 162, 163, 164 is circumferentially at a distance from the two inserts adjacent to it.

An assembly according to a fourth embodiment will now be described with reference to FIG. 11, comprising a tyre and the set of a plurality of inserts according to the second embodiment. Elements similar to those described in the preceding embodiments are denoted by identical reference signs.

Unlike in the assembly of the third embodiment, each uncovered portion 265, 266, 267, 268 is capable of interacting with each of the inserts 161, 162, 163, 164. The user can thus position the inserts 161, 162, 163, 164 as they see fit, without being dependent on prepositioned portions on the sidewall of the tyre.

An assembly according to a fifth embodiment will now be described with reference to FIGS. 12 and 13, comprising an insert according to a fourth embodiment. Elements similar to those described in the preceding embodiments are denoted by identical reference signs.

Unlike the previous embodiments, the means 50 for fastening the insert 16 to the sidewall 26 of the tyre 12 through reversible elastic clipping comprise two fastening tabs 52, 54, each tab 52, 54 being borne by each radially inner and outer edge 40, 42 of the insert 16.

An insert according to a fifth embodiment will now be described with reference to FIG. 14. Elements similar to those described in the preceding embodiments are denoted by identical reference signs.

Unlike the insert of the first embodiment, the visible face 44 is polychrome and has a single appearance texture. In this instance, the visible face 44 comprises first portions 441 having two different colours and second portions 442 having the same single colour. The texture is the same on the first and second portions 441, 442.

An insert according to a sixth embodiment will now be described with reference to FIG. 15. Elements similar to those described in the preceding embodiments are denoted by identical reference signs.

Unlike the insert of the first embodiment, the insert 16 comprises a first part 13 formed from a first monolithic material and intended to be visible when the insert is fastened to the sidewall of the tyre. The insert 16 comprises a second part 15 formed from a second monolithic material different from the first monolithic material and comprising the means 50 for fastening through reversible elastic clipping. Here, the first monolithic material comprises a polymeric material, here polypropylene, and the second monolithic material is metallic, here steel.

An insert according to a seventh embodiment will now be described with reference to FIG. 16A. Elements similar to those described in the preceding embodiments are denoted by identical reference signs.

Here, each first and second circumferential end 32, 34 bears complementary means 66, 67 for locking each first and second circumferential end 32, 34 to each other between:
an unlocked position, shown in FIG. 16A, in which each first and second circumferential end 32, 34 is movable relative to the other end, and
a locked position in which each first and second circumferential end 32, 34 is fixed relative to the other end and in which the complementary locking means 66, 67 interact with each other.

Here, the complementary locking means 66, 67 comprise means for locking through reversible elastic clipping comprising a male tab 68 borne by the circumferential end 32 and a complementary recess 70 made in the circumferential end 34.

When the insert 16 is mounted on the tyre 12, the locking means 66, 67 are in an overlapping region 71 that is not taken into account for determining the angular sector, which is determined on the basis of the two free end edges 36, 38.

In a variant of the insert in FIG. 16A illustrated in FIG. 16B, the insert 16 is not provided with locking means borne by the first and second circumferential ends 32, 34, but comprises first and second circumferential ends 32, 34 having a tapered profile that respectively complements each second and first circumferential end 34, 32 in at least part of the overlapping region 71 between the first and second circumferential ends 32, 34.

A set of a plurality of inserts according to a third embodiment will now be described with reference to FIG. 17. Elements similar to those described in the preceding embodiments are denoted by identical reference signs.

Unlike the set according to the first embodiment illustrated in FIGS. 7 and 8, each insert 161, 162, 163, 164 in the set 17 according to the third embodiment comprises locking means 66, 67 similar to those described with reference to FIG. 16A. Each first and second circumferential end 32, 34 respectively bears first and second complementary means 66, 67 for locking each first and second circumferential end to each other between:
an unlocked position, illustrated in FIG. 17, in which each first and second circumferential end 32, 34 is movable relative to a second and a first circumferential end 34, 32 respectively of an insert bearing identical complementary locking means 66, 67, and
a locked position in which each first and second circumferential end 32, 34 is fixed relative to a second and a first circumferential end 34, 32 respectively of an insert bearing identical complementary locking means 66, 67 and in which the complementary locking means 66, 67 of the two inserts interact with each other.

An insert according to eighth and ninth embodiments will now be described with reference to FIGS. 18 and 19. Elements similar to those described in the preceding embodiments are denoted by identical reference signs.

In the eighth embodiment in FIG. 18, the insert 16 forms a ring 30 that is discontinuous at a single point in a similar manner to the embodiments in FIGS. 3 and 14. Unlike these embodiments, each radially inner and outer edge 40, 42 follows a broken curve around the central point between each first and second free end edge 36, 38.

In the ninth embodiment in FIG. 19, the insert 16 also forms a ring 30 that is discontinuous at a single point in a similar manner to the embodiments in FIGS. 3, 14 and 18. Unlike these embodiments, each radially inner and outer edge 40, 42 follows an undulating curve around the central point between each first and second free end edge 36, 38.

It will be noted that variants of the eighth and ninth embodiments can be envisaged in which a set of a plurality of inserts following a straight curve (for the eighth embodiment) or an arc of a circle (for the ninth embodiment) makes it possible, once the inserts form the set, to form a ring that is discontinuous at a plurality of points.

An assembly according to a sixth embodiment will now be described with reference to FIG. 20, comprising inserts according to tenth and eleventh embodiments.

The assembly 18 comprises a first insert 161 and a second insert 162. The first insert 161 forms an angular sector of a circular ring substantially equal to (360°—A)/N with N≥2 and A ranging from 10° to 330°. Here, N=8 and A=160°, so that the angular sector of first insert is substantially equal to 25°. The second insert 162 forms an angular sector of a circular rin g ranging from 330° to 380° and here equal to 335°. The set of first and second inserts 161, 162 forms a ring 30 that is discontinuous at two points. In this embodiment, during the mounting method, each first and second insert 161, 162 being such that there is sufficient space between each free end edge 36, 38 to allow each first and second insert 161, 162 to pass around the fork arm 56, the branch of the swing arm or the hub 58 of the mounted assembly 10 without moving one free end edge 36, 38 relative to the other, thefork arm 56, the branch of the swing arm or the hub 58 of the mounted assembly 10 is passed into the space between each free end edge 36, 38.

The invention is not limited to the embodiments described above.

The different embodiments described above can be combined, and in particular the embodiments in FIGS. 8 and 11 can be combined.

The features of the means for fastening the insert in FIGS. 12 and 13 can also be applied to the other embodiments.

Although the figures only illustrate a single sidewall of the tyre, the invention can obviously be used on both sidewalls of the tyre.

Finally, according to the invention, the invention can be used on a mounted assembly intended to be mounted or mounted on a branch of a swing arm of a motorcycle.

1.-15. (canceled)

16. An insert (16) for a sidewall (26) of a motorcycle tire (12) that is capable of being removably fastened to a sidewall (26) of the motorcycle tire (12),
wherein a sidewall insert (16) forms an angular sector of a ring, the angular sector ranging from 330° to 380°, and
wherein the insert (16) comprises two free end edges (36, 38) arranged so that, when the tire (12) is mounted on a mounting support (14) in order to form a mounted assembly (10) and when the mounted assembly (10) is mounted on the motorcycle, the insert (16) can be mounted on and removed from the sidewall (26) of the tire (12) without removing the mounted assembly (10) from the motorcycle.

17. The insert (16) according to claim 16, wherein the sidewall insert forms the angular sector of a circular ring.

18. The insert (16) according to claim 17, further comprising a radially inner edge (40) and a radially outer edge (42), each of the radially inner edge and the radially outer edge (40, 42) following a circular curve.

19. The insert (16) according to claim 16, further comprising removable means (48) for fastening the insert (16) to the sidewall (26) of the tire (12) comprising means (50) for fastening the insert (16) to the sidewall (26) of the tire (12) through reversible elastic clipping.

20. An assembly (18) of a motorcycle tire (12) and at least one insert (16; 161, 162, 163, 164) for a sidewall (26) of the tire (12), the or each insert (16; 161, 162, 163, 164) being removably fastened to the sidewall (26),
wherein the or each sidewall insert (16; 161, 162, 163, 164) comprises two free end edges (36, 38) arranged so that, when the tire (12) is mounted on a mounting support (14) in order to form a mounted assembly (10) and when the mounted assembly (10) is mounted on the motorcycle, the insert (16; 161, 162, 163, 164) can be mounted on and removed from the sidewall (26) of the tire (12) without removing the mounted assembly (10) from the motorcycle.

21. The assembly (18) according to claim 20, wherein the assembly comprises a single insert (16) for a sidewall (26) removably fastened to the sidewall (26), the sidewall insert (16) forming an angular sector of a ring, the angular sector ranging from 330° to 380°.

22. The assembly (18) according to claim 20, wherein the assembly comprises N≥2 inserts (161, 162, 163, 164) for a sidewall (26) removably fastened to the sidewall (26),
each sidewall insert (161, 162, 163, 164) forming an angular sector of a ring, the angular sector of each sidewall insert being substantially equal to 360°/N,
the sidewall (26) comprising N portions (261, 262, 263, 264) arranged circumferentially adjacent to each other, and
each of the N inserts (161, 162, 163, 164) interacting with each portion of the sidewall arranged circumferentially adjacent to each other (261, 262, 263, 264) so that they fully form a discontinuous ring.

23. The assembly (18) according to claim 20, wherein the assembly comprises N≥2 inserts (161, 162, 163, 164) for a sidewall (26) removably fastened to the sidewall (26),
each sidewall insert (161, 162, 163, 164) forming an angular sector of a ring, the angular sector of each sidewall insert being substantially equal to (360°—A)/N with A ranging from 10° to 330°, and
the sidewall (26) comprising:
N covered portions (261, 262, 263, 264) of the sidewall (26) interacting with each of the N inserts (161, 162, 163, 164), and
N′≥2 uncovered portions (265, 266, 267, 268) of the sidewall (26) without a sidewall insert,
each covered portion (261, 262, 263, 264) of the sidewall (26) being circumferentially adjacent to and arranged between two uncovered portions (265, 266, 267, 268) of the sidewall (26).

24. A method for mounting an insert (16) on a sidewall (26) of a motorcycle tire (12), the insert (16) being capable of being removably fastened to the sidewall (26) of the motorcycle tire (12), the sidewall insert (16) forming an angular sector of a ring, the angular sector ranging from 330° to 380°, and the insert (16) comprising two free end edges (36, 38), the method comprising:
passing the insert (16) around a fork arm (56), a branch of a swing arm or a hub (58) of the mounted assembly (10) of the motorcycle, each free end edge (34, 36) being axially offset relative to the other so as to allow the insert (16) to pass around the fork arm (56), the branch of the swing arm or the hub (58) of the mounted assembly (10), and/or each free end edge (34, 36) being circumferentially separated from the other so as to allow the insert (16) to pass around the fork arm (56), the branch of the swing arm or the hub (58) of the mounted assembly (10); and
removably fastening the insert (16) to the sidewall (26).

25. A method for mounting a plurality of inserts (161, 162, 163, 164) on a sidewall (26) of a motorcycle tire (12), each sidewall insert (161, 162, 163, 164) being capable of being removably fastened to the sidewall (26) of the motorcycle tire (12), each sidewall insert (16) forming an angular sector of a ring and comprising two free end edges (36, 38), the angular sector of each sidewall insert being substantially equal to 360°/N with N≥2, or the angular sector of each sidewall insert being substantially equal to (360°—A)/N with N≥2 and A ranging from 10° to 330°, the method comprising:
passing each sidewall insert around a fork arm (56), a branch of a swing arm of the motorcycle or a hub (58) of the mounted assembly (10),
where the or each sidewall insert (161, 162, 163, 164) being such that there is sufficient space between each free end edge (36, 38) to allow the or each sidewall insert (161, 162, 163, 164) to pass around the fork arm (56), the branch of the swing arm or the hub (58) of the mounted assembly (10) without moving one free end edge (36, 38) relative to the other, the fork arm (56), the branch of the swing arm or the hub (58) of the mounted assembly (10) is passed into the space between each free end edge (36, 38), or
where the or each sidewall insert (161, 162, 163, 164) being such that there is insufficient space between each free end edge (36, 38) to allow the or each sidewall insert (161, 162, 163, 164) to pass around the fork arm (56), the branch of the swing arm or the hub (58) of the mounted assembly (10),
each free end edge (36, 38) is axially offset relative to the other so as to allow each sidewall insert (161, 162, 163, 164) to pass around the fork arm, the branch of the swing arm or the hub (58) of the mounted assembly (10), and/or
each free end edge (36, 38) is circumferentially separated from the other so as to allow the fork arm, the branch of the swing arm or the hub (58) of the mounted assembly (10) to pass into the space between each free end edge (36, 38); and
removably fastening each sidewall insert (161, 162, 163, 164) to the sidewall (26).
